(19) United States
(12) Patent Application Publication
(10) Pub. No.: US 2025/0346695 A1
(43) Pub. Date: Nov. 13, 2025

(54) ETHYLENE BASED CO/TERPOLYMERS CONTAINING A HIGH PURITY -S-S- BASED DYNAMIC CROSSLINKER TO PRODUCE AN IN-REACTOR DYNAMIC MATERIAL

(71) Applicant: Braskem America, Inc., Philadelphia, PA (US)

(72) Inventors: Sarah Mitchell, Pittsburgh, PA (US); Hadi Mohammadi, Pittsburgh, PA (US)

(21) Appl. No.: 19/200,969

(22) Filed: May 7, 2025

Related U.S. Application Data
(60) Provisional application No. 63/645,341, filed on May 10, 2024.
(60) Provisional application No. 63/796,331, filed on Apr. 28, 2025.

(51) Int. Cl. C08F 210/02; C08F 2/01; C08F 2/34; C08K 5/14

(52) U.S. Cl. CPC C08F 210/02; C08K 5/14; C08F 2/01; C08F 2/34; C08F 2400/02; C08F 2400/04

(57) ABSTRACT

A method of making a polymer that includes reacting an olefin in the presence of an ensemble of crosslinker molecules, each molecule of the ensemble comprising a —Sₙ— moiety and having at least two polymerizable groups, wherein n is an integer of from 1 to 8, in the presence of a polymerization initiator, to produce a reversibly-crosslinked polymer that includes crosslinking bonds, said crosslinking bonds being bonds that dissociate when the reversibly-crosslinked polymer is reprocessed at temperatures 50° C. or greater, where, for at least 90% of the crosslinkers molecules in the ensemble, n is equal to 2.

### PRIORITY CLAIM

This application claims priority under 35 U.S.C. § 119 (e) to U.S. Provisional Application No. 63/796,331, filed Apr. 28, 2025, and U.S. Provisional Application No. 63/645,341, filed May 10, 2024, both of which are herein incorporated by reference in their entirety.

### BACKGROUND OF THE INVENTION

Conventional polymer thermosets consist of permanent covalent crosslinks that make recycling these networks very challenging and can lead to high cost and energy consumption. One solution to this problem is to incorporate inherently reversible crosslinks into the polymer network, which can allow for the polymer networks to be re-processed, while maintaining the properties of the original network. A typical method to produce a thermoset is to crosslink a conventional thermoplastic with a crosslinking agent in a post-polymerization process. Examples of thermoplastics that are crosslinked for various applications include low density polyethylene (LDPE) and ethylene/VA copolymer (EVA). Disulfide bonds are dynamic bonds were upon heating, the disulfide bond dissociates to form a stable thionitroxide radical. When cooled back to room temperature the disulfide bond reforms. A disulfide bond can be incorporated into a crosslinker where the polymerizable ends of the crosslinker allow for incorporation into a polymer network, including ethylene-based polymers and copolymers. The resulting polymer network containing the disulfide bond is dynamic, allowing for the polymer to be re-processed when heated to temperatures of 50° C. or greater, such as <200° C., and the original polymer properties is maintained.

### BRIEF SUMMARY OF THE INVENTION

An embodiment of the present invention relates to a method of making a polymer, comprising: reacting an olefin in the presence of an ensemble of crosslinker molecules, each molecule of the ensemble comprising a —Sₙ— moiety and having at least two polymerizable groups, wherein n is an integer of from 1 to 8, in the presence of a polymerization initiator, to produce a reversibly-crosslinked polymer that comprises crosslinking bonds, said crosslinking bonds being bonds that dissociate when the reversibly-crosslinked polymer is reprocessed at temperatures 50° C. or greater, wherein, for at least 90% of the crosslinkers molecules in the ensemble, n is equal to 2.

Another embodiment of the present invention relates to a method above, wherein the ensemble of crosslinker molecules comprises molecules represented by Formula (I), (II), (III), (IV), (V), or (VI):

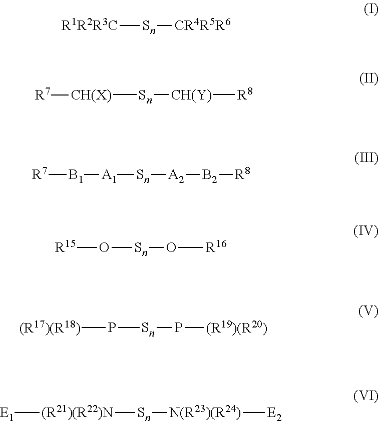

wherein:
n is an integer of from 2 to 8,
X represents CHR⁹R¹⁰, OH, SH, or NHR¹¹;
Y represents CHR¹²R¹³, OH, SH, or NHR¹⁴;
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silcone having from 1 to 20 carbon atoms; each optionally substituted by one or more alkyl, alkenyl, hydroxyl, or halogen atoms, wherein adjacent R groups can form together to form a saturated or unsaturated hydrocarbon ring;
each of A₁ and A₂ is independently absent, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, amide, ether, or ester, or combinations thereof;
each of E₁ and E₂ is independently a (meth)acrylate, (meth)acrylamide, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms,
provided the following:
in Formula (I), at least one of R¹, R², and R³ comprises a C═C double bond and at least one of R⁴, R⁵, and R⁶ comprise a C═C double bond,
in Formula (II) and (III), each of R⁷ and R⁸ comprises a C═C double bond,
in Formula (IV), each of R¹⁵ and R¹⁶ comprises a C═C double bond,
in Formula (V), each of R¹⁷, R¹⁸, R¹⁹, and R²⁰, comprises a C═C double bond, and
in Formula (VI), each of E₁ and E₂ comprises a C═C double bond,
wherein, for at least 90% of the crosslinkers molecules in the ensemble, n is equal to 2.

Another embodiment of the present invention relates to a method above, wherein, for at least 91% of the crosslinkers molecules in the ensemble, n is equal to 2.

Another embodiment of the present invention relates to a method above, wherein, for at least 92% of the crosslinkers molecules in the ensemble, n is equal to 2.

Another embodiment of the present invention relates to a method above, wherein, for at least 93% of the crosslinkers molecules in the ensemble, n is equal to 2.

Another embodiment of the present invention relates to a method above, wherein, for at least 94% of the crosslinkers molecules in the ensemble, n is equal to 2.

Another embodiment of the present invention relates to a method above, wherein, for at least 95% of the crosslinkers molecules in the ensemble, n is equal to 2.

Another embodiment of the present invention relates to a method above, wherein, for at least 96% of the crosslinkers molecules in the ensemble, n is equal to 2.

Another embodiment of the present invention relates to a method above, wherein, for at least 97% of the crosslinkers molecules in the ensemble, n is equal to 2.

Another embodiment of the present invention relates to a method above, wherein, for at least 98% of the crosslinkers molecules in the ensemble, n is equal to 2.

Another embodiment of the present invention relates to a method above, wherein, for at least 99% of the crosslinkers molecules in the ensemble, n is equal to 2.

Another embodiment of the present invention relates to a method above, wherein said reacting is carried out under a pressure of at least 20 bar.

Another embodiment of the present invention relates to a method above, wherein said reacting is carried out under a pressure of from 20 bar to 5,000 bar.

Another embodiment of the present invention relates to a method above, wherein said reacting is carried out under a pressure of from 1500 bar to 2000 bar.

Another embodiment of the present invention relates to a method above, wherein the polymerization initiator is a free-radical initiator, a thermal initiator, radiation or irradiation, or any combination thereof.

Another embodiment of the present invention relates to a method above, wherein the polymerization initiator is present in an amount of from 1×10⁻⁷ to 5 wt %, relative to 100 wt % of the total amount of the ensemble of crosslinker molecules, olefin, and the polymerization initiator.

Another embodiment of the present invention relates to a method above, wherein the polymerization initiator comprises at least one member selected from the group consisting of a peroxide, an azo compound, a peracetate compound, and a nitroxide.

Another embodiment of the present invention relates to a method above, wherein the polymerization initiator comprises at least one member selected from the group consisting of di(2-ethylhexyl) peroxydicarbonate (EHPC), tert-amyl peroxypivalate (TAPPI); tert-butylperoxy-2-ethylhexanoate (TBPEH); tert-butylperoxyacetate (TBPA); azobisisobutyronitrile (AIBN); 2,2′-azobis(amidinopropyl)dihydrochloride; 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; 3,4-dibenzyl-3,4-diphenylhexane; and an azo-peroxide initiator that comprises a peroxide and at least one azodinitrile compound selected from the group consisting of 2,2′-azobis (2-methyl-pentanenitrile); 2,2′-azobis (2-methyl-butanenitrile); 2,2′-azobis (2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; 2-[(1-cyano-1-methylpropyl)azo]-2-ethyl-pentanenitrile

Another embodiment of the present invention relates to a method above, wherein said reacting is carried out as a batch reaction or a continuous reaction, under a pressure of at least 20 bar.

Another embodiment of the present invention relates to a method above, wherein said reacting is carried out at a temperature of at least 70° C.

Another embodiment of the present invention relates to a method above, wherein said reacting is carried out at a temperature of from 70° C. to 350° C.

Another embodiment of the present invention relates to a method above, wherein said reacting is carried out at a temperature of from 150° C. to 350° C.

Another embodiment of the present invention relates to a method above, wherein the ensemble of crosslinker molecules comprises at least one member selected from the group consisting of bis(2-methacryloyl)oxyethyl disulfide, disulfanediylbis(3,1-phenylene)diacrylate, disulfanediylbis(ethane-2,1-diyl)diacrylate, N,N′-(disulfanediylbis(2,1-phenylene))diacrylamide, N,N′-(disulfanediylbis(4,1-phenylene))diacrylamide, N,N′-bis(acryloyl)cystamine, 4,13-dioxo-5,12-dioxa-8,9-dithia-3,14-diazahexadecane-1,16-diyl bis(2-methylacrylate), and bis(2,2,6,6-tetramethyl-4-piperidyl)disulfide.

Another embodiment of the present invention relates to a method above, wherein the ensemble of crosslinker molecules comprises bis(2,2,6,6-tetramethyl-4-piperidyl) disulfide.

Another embodiment of the present invention relates to a method above, wherein the crosslinking bonds are sulfur-sulfur bonds that dissociate at temperatures 50° C. or greater.

Another embodiment of the present invention relates to a method above, wherein the olefin comprises at least one member selected from the group consisting of ethylene, propylene, 1-butylene, 1-pentene, 1-hexene, 1-heptene, 1-octene, and vinyl acetate.

Another embodiment of the present invention relates to a method above, wherein the olefin comprises ethylene, propylene, a combination of ethylene and vinyl acetate, or a combination thereof.

Another embodiment of the present invention relates to a method above, which is carried out in a gas-phase reactor.

### BRIEF DESCRIPTION OF SEVERAL VIEWS OF THE DRAWING

FIG. 1 shows a polymerization overview of a reaction between Crosslinker A (biTEMPS methacrylate, biTEMPS-S2) and ethylene with a radical initiator.

FIG. 2 shows a DSC graph of the polyethylene polymer of sample A2.

FIG. 3 shows a DMA graph of the polyethylene polymer of sample A2.

FIG. 4 shows the DMA graphs of polymer samples C5-C7 (A) and polymer samples C8-C10 (B).

### DETAILED DESCRIPTION OF THE INVENTION

One embodiment of the present invention relates to a method of making a polymer, comprising: reacting an olefin in the presence of an ensemble of crosslinker molecules, each molecule of the ensemble comprising a —Sₙ— moiety and having at least two polymerizable groups, wherein n is an integer of from 1 to 8, in the presence of a polymerization initiator, to produce a reversibly-crosslinked polymer that comprises crosslinking bonds, said crosslinking bonds being bonds that dissociate when the reversibly-crosslinked polymer is reprocessed at temperatures 50° C. or greater, wherein, for at least 90% of the crosslinkers molecules in the ensemble, n is equal to 2.

In some embodiments, the ensemble of crosslinker molecules comprises molecules represented by Formula (I), (II), (III), (IV), (V), or (VI):

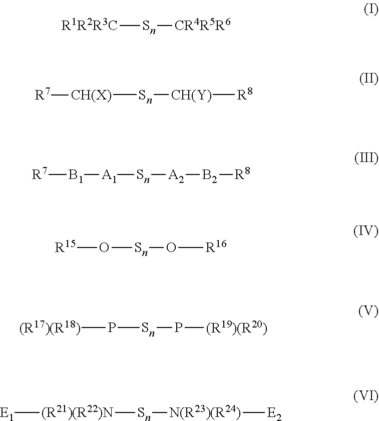

Integer n is from 2 to 8, such as 2 or 5, 2 to 4, or 2 to 3. Typically, n is 2 or 3. In one embodiment, n is 2. In one embodiment, n is 3.

Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silcone having from 1 to 20 carbon atoms. Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ can be optionally substituted by one or more alkyl, alkenyl, hydroxyl, or halide groups. The optional substituents replace the hydrogen atom(s) of these R variables. Exemplary substituents are C1-C6 alkyl (linear or branched), C2-C6 alkenyl, hydroxyl, or halide groups.

X represents CHR⁹R¹⁰, OH, SH, or NHR¹¹. Y represents CHR¹²R¹³, OH, SH, or NHR¹⁴.

Each of A¹ and A² is independently absent, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms.

Each of B₁ and B₂ is independently absent or a divalent form of imine, amine, amide, ether, or ester, or combinations thereof. The term “divalent form” refers to a divalent radical that is formed when a hydrogen atom is removed from a functional group, e.g., a radical of alkyl, alkenyl, cycloalkyl, or alkynyl, etc., or when terminal hydrogen atoms are removed from a hydrocarbon, e.g., an alkane, alkene, cycloalkane, or alkyne, etc. For instance, in the case of divalent form of alkene (alkenylene), the term refers to a divalent radical that has hydrogen atoms removed from each of the two terminal carbon atoms of the alkene chain. A divalent form of a moiety is defined to represent the moiety present in the middle of a structural formula, with each end of the moiety bonding to another moiety, bond, or hydrogen atom.

Each of E₁ and E₂ is independently a (meth)acrylate group, (meth)acrylamide, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms. Examples of a C₁-C₂₀ alkylene include methylene, ethylene, 2,2-dimethylethylene, propylene, 2-methylpropylene, butylene, and pentylene. Examples of a C₃-C₂₀ cycloalkylene include a cyclopentyl group and a cyclohexyl group. In embodiments, each E₁ and E₂ comprises a double bond that can participate in the reacting of the method of the present invention.

In some embodiments, the ensemble of crosslinker molecules comprises molecules represented by Formula (I). In Formula (I), at least one of R¹, R², and R³ comprises a C═C double bond and at least one of R⁴, R⁵, and R⁶ comprise a C═C double bond. R¹, R², R³, R⁴, R⁵, and R⁶ may be the same or different. (R¹R²R³) and (R⁴R⁵R⁶) may be the same or different. In some embodiments, each of R¹ and R⁴ is H; each of R² and R⁵ may be H or alkyl, and each of R³ and R⁶ comprises a C═C double bond. In some embodiments, each of R³ and R⁶ independently comprises an alkene, an alkyne, a nitrile, an acyl, an acrylate, a (meth)acrylate, a styrene, or a vinyl pyridine.

In some embodiments, the ensemble of crosslinker molecules comprises molecules represented by Formula (II). In Formula (II), each of R⁷ and R⁸ comprises a C═C double bond. X and Y may be the same or different. R⁷ and R⁸ may be the same or different. R⁷—CH(X)— and —CH(Y)—R⁸ may be the same or different. In some embodiments, each of X and Y independent represents CHR⁹R¹⁰, OH, SH, or NHR¹¹, wherein each of R⁹, R¹⁰, and R¹¹ is independently H or alkyl. In some embodiments, each of X and Y independent represents CHR⁹R¹⁰ or NHR¹¹, wherein each of R⁹, R¹⁰, and R¹¹ is independently H or methyl. In some embodiments, each of R⁷ and R⁸ independently comprises an alkene, an alkyne, a nitrile, an acyl, an acrylate, a (meth)acrylate, a styrene, or a vinyl pyridine.

In some embodiments, the ensemble of crosslinker molecules comprises molecules represented by Formula (III). In Formula (III), each of R⁷ and R⁸ comprises a C═C double bond. A₁ and A₂ may be the same or different. B₁ and B₂ may be the same or different. R⁷ and R⁸ may be the same or different. R⁷-B₁-A₁- and -A₂-B₂-R⁸ may be the same or different. In some embodiments, each of A₁ and A₂ is independently absent, a C₁-C₅ alkylene, a C₃-C₆ cycloalkylene, or a phenylene; each optionally substituted by one or more alkyl, hydroxyl, or halogen atoms. In some embodiments, each of B₁ and B₂ is independently absent or a divalent form of amine, amide, or ester. In some embodiments, each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R₇ and R₈ is independently comprises a C₂-C₆ alkynyl optionally substituted by one or more C₁-C₃ alkyl or a nitrile.

In some embodiments, the ensemble of crosslinker molecules comprises molecules represented by Formula (III). In Formula (III), each of R⁷ and R⁸ is independently a C₂-C₂₀ alkenyl, optionally substituted by one or more alkyl or alkenyl. Each of A₁ and A₂ is independently absent, a C₁-C₂₀ alkylene or a divalent form of phenyl. Each optionally substituted by one or more alkyl, alkenyl, hydroxyl, or halogen atoms. Each of B₁ and B₂ is independently absent or a divalent form of amine, amide, ether, or ester.

In some embodiments, a crosslinker in the ensemble has the structure of formula:

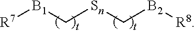

The integer n is 2 or 3. In one embodiment, n is 2. In one embodiment, n is 3. The integer t is 1 to 5, for instance 1 to 4, or 1 to 3. In one embodiment, t is 1. In one embodiment, t is 2. In one embodiment, t is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)—, or —C(O)N(H)—. In some embodiments, each of B₁ and B₂ is independently absent, —OC(O)—, —C(O)O—, —N(H)C(O)—, or —C(O)N(H)—.

In some embodiments, a crosslinker in the ensemble has the structure of formula:

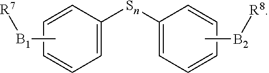

The integer n is 2 or 3. In one embodiment, n is 2. The integer n is 2 or 3. In one embodiment, n is 2. In one embodiment, n is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)—, or —C(O)N(H)—. In some embodiments, each of B₁ and B₂ is independently —OC(O)—, —C(O)O—, —N(H)C(O)—, or —C(O)N(H)—.

Exemplary crosslinker molecules in the ensemble are:

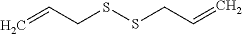

diallyl disulfide,

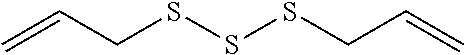

diallyl trisulfide,

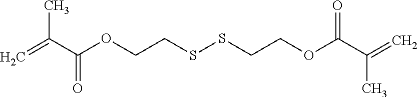 [SMILES: C=C(C)C(=O)OCCSSCCOC(=O)C(=C)C]

bis(2-methacryloyl)oxyethyl disulfide,

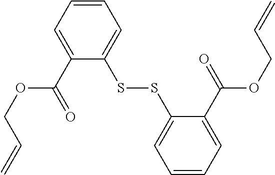 [SMILES: C=CCOC(=O)c1ccccc1SSc1ccccc1C(=O)OCC=C]

diallyl 2,2′-disulfanediyldibenzoate,

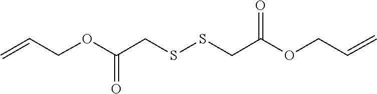 [SMILES: C=CCOC(=O)CSSCC(=O)OCC=C]

diallyl 2,2′-disulfanediyldiacetate,

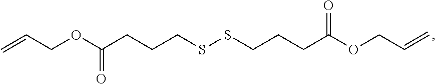 [SMILES: C=CCOC(=O)CCCSSCCCC(=O)OCC=C]

diallyl 4,4′-disulfanediyldibutyrate

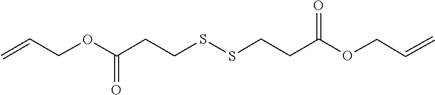 [SMILES: C=CCOC(=O)CCSSCCC(=O)OCC=C]

diallyl 3,3′-disulfanediyldipropionate,

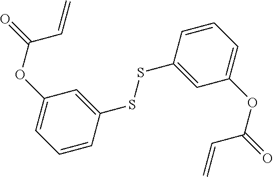 [SMILES: C=CC(=O)Oc1cccc(SSc2cccc(OC(=O)C=C)c2)c1]

disulfanediylbis(3,1-phenylene)diacrylate,

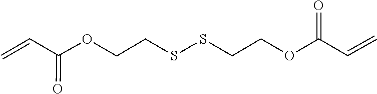 [SMILES: C=CC(=O)OCCSSCCOC(=O)C=C]

disulfanediylbis(ethane-2,1-diyl)diacrylate,

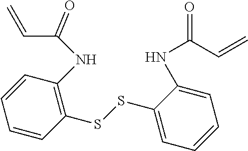 [SMILES: C=CC(=O)Nc1ccccc1SSc1ccccc1NC(=O)C=C]

N,N′-(disulfanediylbis(2,1-phenylene))diacrylamide,

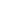

N,N′-(disulfanediylbis(4,1-phenylene))diacrylamide, and

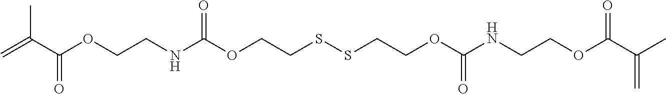 [SMILES: C=C(C)C(=O)OCCNC(=O)OCCSSCCOC(=O)NCCOC(=O)C(=C)C]

4,13-dioxo-5,12-dioxa-8,9-dithia-3,14-diazahexadecane-1,16-diyl bis(2-methylacrylate), and

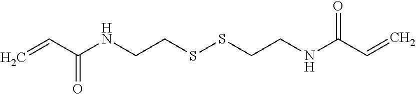 [SMILES: C=CC(=O)NCCSSCCNC(=O)C=C]

N,N′-Bis(acryloyl)cystamine.

In some embodiments, the ensemble of crosslinker molecules comprises molecules represented by (IV). In Formula (IV), each of R¹⁵ and R¹⁶ comprises a C═C double bond. Each of R¹⁵ and R¹⁶ is independently a C₁-C₂₀ alkyl, a C₃-C₂₀ cycloalkyl, or a C₂-C₂₀ alkenyl, optionally substituted by one or more alkyl or alkenyl.

Exemplary crosslinker molecules in the ensemble, of Formula (IV), are:

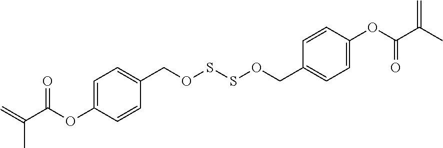 [SMILES: C=C(C)C(=O)Oc1ccc(COSSOCc2ccc(OC(=O)C(=C)C)cc2)cc1]

((disulfanediylbis(oxy))bis(methylene))bis(4,1-phenylene)bis(2-methylacrylate),

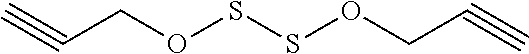

1,2-bis(prop-2-yn-1-yloxy)disulfane, and

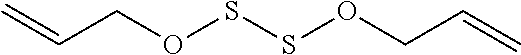

1,2-bis(allyloxy)disulfane.

Exemplary crosslinker molecules in the ensemble, of Formula (IV), are:

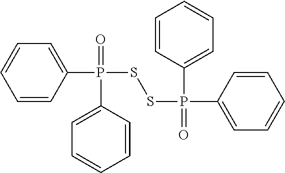 [SMILES: O=P(SSP(=O)(c1ccccc1)c1ccccc1)(c1ccccc1)c1ccccc1]

diphenylphosphinic dithioperoxyanhydride, and

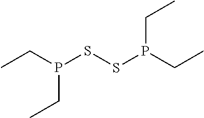

1,2-bis(diethylphosphaneyl)disulfane, provided that each structure contains at least two double bonds.

In some embodiments, the ensemble of crosslinker molecules comprises molecules represented by (V). In Formula (V), at least one of R¹⁷ and R¹⁸ comprises a C═C double bond. In Formula (V), at least one of R¹⁹ and R²⁰ comprises a C═C double bond. Each of R¹⁷, R¹⁸, R¹⁹, and R²⁰ is independently a C₁-C₂₀ alkyl, a C₃-C₂₀ cycloalkyl, or a C₂-C₂₀ alkenyl, optionally substituted by one or more alkyl or alkenyl.

In some embodiments, the ensemble of crosslinker molecules comprises molecules represented by (VI). In Formula (VI), each of E₁ and E₂ comprises a C═C double bond. Each of R²¹, R²², R²³, and R²⁴ is independently a C₁-C₂₀ alkyl, a C₃-C₂₀ cycloalkyl, or a C₂-C₂₀ alkenyl, optionally substituted by one or more alkyl or alkenyl.

In some embodiments, the ensemble of crosslinker molecules comprises molecules represented by Formula (VIa)

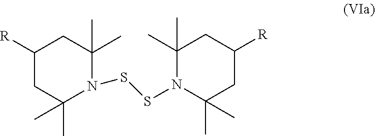

where, in Formula (VIa), each R represents the polymerizable group comprising the carbon-carbon double bond capable of undergoing free radical polymerization.

In some embodiments, the ensemble of crosslinker molecules comprises the following molecules:

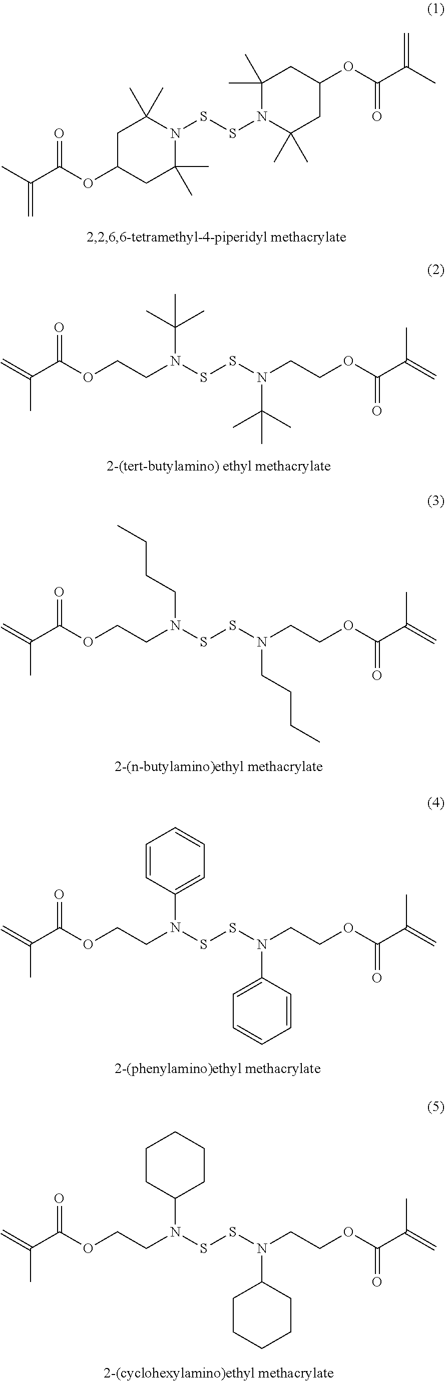

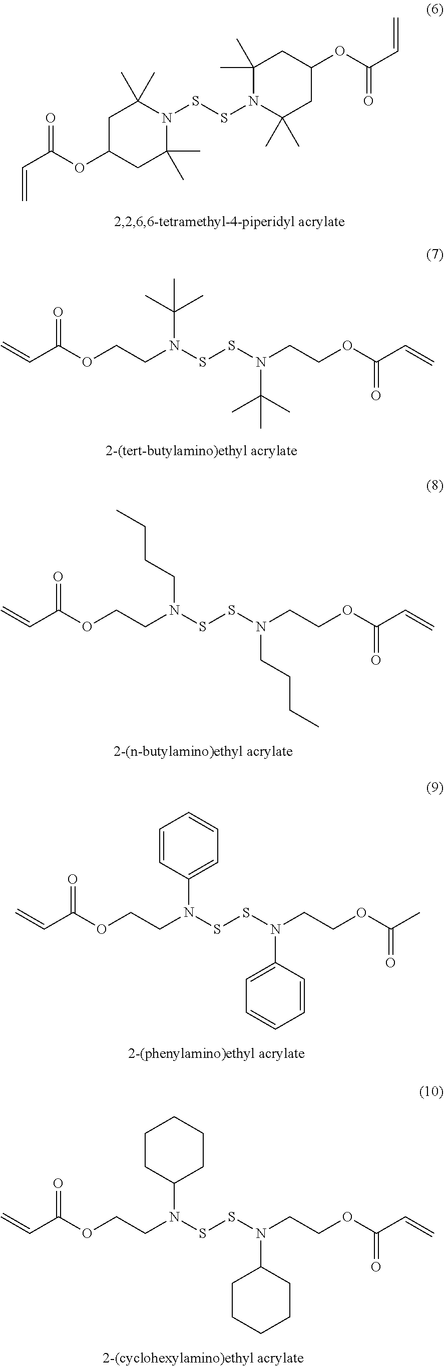

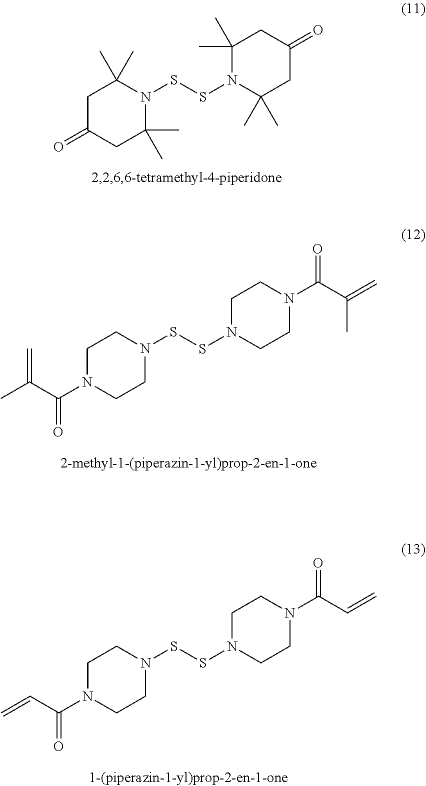

Unless indicated otherwise, the ensemble of crosslinker molecules is defined by a group, a collection, or a plurality of crosslinker molecules, each molecule functioning as a crosslinker. For example, the crosslinker bis(2,2,6,6-tetramethyl-4-piperidyl methacrylate) disulfide (“BiTEMPS”) has a N—Sₙ—N moiety within the molecule, where different, individual BiTEMP molecules can have a n value of 2, 3, 4, 5, 6, 7, or 8. In the present invention, for at least 90% of the crosslinkers molecules in the ensemble, n is equal to 2. Preferably, for at least 91%, 92%, 93%, 94%, 95%, 96%, 97%, 98%, or 99%, of the crosslinkers molecules in the ensemble, n is equal to 2. This percentage value can represent the —S₂— purity of the ensemble of crosslinker molecules. This is the case for any crosslinker molecule of the ensemble, of the present invention.

The crosslinker molecules in the ensemble are dynamic crosslinkers, meaning that the polymer chains of the polymers, formed from polymerization of the ensemble of crosslinkers and the olefins, are covalently linked via a reversible linkage provided by the crosslinker that dissociates at an elevated temperature and reassociates upon cooling. The crosslinker also contains a polymerizable group allowing for its incorporation into a polymer network via polymerization.

The crosslinker comprises a —Sₙ— moiety (n is an integer of from 2 to 8, e.g., 2 or 3) and has at least two polymerizable groups. The dynamic nature comes from the disulfide or polysulfide bond that dissociates to form a stable thiyl radical upon heating, and reassociates back to reform the disulfide or polysulfide bond upon cooling down to room temperature. The polymerizable group can comprise an unsaturated bond capable of polymerization reaction to allow for incorporation of the crosslinker into a polymer network during polymerization reaction. For instance, the polymerizable group can comprise a C═C double bond. The two polymerizable groups may be the same or different. The unsaturated bond (e.g., C═C double bond) capable of undergoing a polymerization reaction is in a functional group including but not limited to an alkene, an alkyne, a nitrile, vinyl group, an acyl, an acrylate, a (meth) acrylate, a styrene, and a vinyl pyridine.

In some embodiments, the crosslinker comprises diallyl disulfide. In one embodiment, the crosslinker consists of diallyl disulfide.

The olefin in the method of making a polymer can comprise an olefin monomer, a vinyl monomer, or a vinyl ester monomer. Herein, vinyl monomer and vinyl ester monomer are included in the terms “olefin” and “olefin monomers.”

Suitable olefin monomers can include a linear or branched olefin (e.g., an α-olefin) having 2 to 12 carbon atoms, 2 to 10 carbon atoms, or 2 to 8 carbon atoms. Exemplary linear or branched olefins includes, but are not limited to, ethylene, propylene, 1-butene, 2-butene, 1-pentene, 3-methyl-1-butene, 4-methyl-1-pentene, 3-methyl-1-pentene, 1-hexene, 3,5,5-trimethyl-1-hexene, 4,6-dimethyl-1-heptene, 1-octene, 1-nonene, 1-decene, 1-undecene, and 1-dodecene. These olefins may contain one or more heteroatoms such as an oxygen, nitrogen, or silicon.

Suitable vinyl monomers can include a substituted vinyl, e.g., R^{a}R^{b}C═CRCR^{d}, wherein R^{a} and R^{b} may each independently be hydrogen, halogen, alkyl, aryl (e.g., phenyl), arylalkyl (e.g., benzyl), heteroaryl (e.g., pyridinyl), alkenyl, arylalkenyl, hydroxylcarbonyl, alkoxycarbonyl, alkylaminecarbonyl, alkylcarbonyloxy, arylcarbonyloxy, or nitrile. Exemplary vinyl monomers include, but are not limited to, styrene, vinyl pyridine, acrylate, methacrylate, acrylonitrile, vinyl ester, vinyl chloride, isoprene.

Suitable vinyl ester monomers include aliphatic vinyl esters having 3 to 20 carbon atoms (e.g., 4 to 10 carbon atoms, or 4 to 7 carbon atoms). Exemplary vinyl esters are vinyl acetate, vinyl formate, vinyl propionate, vinyl valerate, vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester monomers. Common vinyl ester monomers are vinyl acetate, vinyl propionate, vinyl laurate, or vinyl versatate (e.g., the vinyl ester of versatic acid, vinyl neononanoate, or vinyl neodecanoate). Typically, vinyl acetate is used from the perspective of good commercial availability and impurity-treating efficiency at the production. The vinyl esters of neononanoic acid (vinyl neononanoate) and neodecanoic acid (vinyl neodecanoate) are commercial products obtained from the reaction of acetylene with neononanoic acids and neodecanoic acids, respectively, which are commercially available as Versatic acid 9 and Versatic acid 10.

The olefins may be used alone, or two or more different olefins may be used in combination, when being used in the method of making a polymer.

In some embodiments, the olefin comprises at least one member selected from the group consisting of ethylene, propylene, 1-butene, 1-pentene, 1-hexene, 1-heptene, 1-octene, and vinyl acetate.

In one embodiment, the olefin is ethylene.

In one embodiment, the olefin is ethylene and vinyl acetate.

In an embodiment, the polymerization initiator comprises at least one member selected from the group consisting of di(2-ethylhexyl)peroxydicarbonate (EHPC), tert-amyl peroxypivalate (TAPPI); tert-butylperoxy-2-ethylhexanoate (TBPEH); tert-butylperoxyacetate (TBPA); azobisisobutyronitrile (AIBN); 2,2′-azobis(amidinopropyl)dihydrochloride; 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; 3,4-dibenzyl-3,4-diphenylhexane; and an azo-peroxide initiator that comprises a peroxide and at least one azodinitrile compound selected from the group consisting of 2,2′-azobis (2-methyl-pentanenitrile); 2,2′-azobis (2-methyl-butanenitrile); 2,2′-azobis (2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; 2-[(1-cyano-1-methylpropyl)azo]-2-ethyl-pentanenitrile

Exemplary peroxide compounds used as the polymerization initiator are benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide)hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide)valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentano1; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy)hexane; 2,5-dimethyl-2,5-di(t-amylperoxy)hexane; 2,5-dimethyl-2,5-di(t-butylperoxy)hexyne-3,2,5-dimethyl-2,5-di(t-amylperoxy)hexyne-3, 2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyljbenzene; 1,3-dimethyl-3-(t-butylperoxy)butanol; 1,3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobomyl)peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl) 1-methylethyl]carbamate; 1,3-dimethyl-3-(t-amylperoxy)butyl N-[1-{3 (1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1, 4, 7-triperoxynonane (or methyl ethyl ketone peroxide cyclic trimer); methyl ethyl ketone peroxide cyclic dimer; 3,3,6,6,9,9-hexamethyl-1,2,4,5-tetraoxacyclononane; 2,5-dimethyl-2,5-di(benzoylperoxy)hexane; t-butyl perbenzoate, t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,-tris[2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide, succinic acid peroxide, dibenzoyl peroxide; di(2,4-dichloro-benzoyl)peroxide; and combinations thereof.

During the reacting step, the one or more olefins form a polymer network via the at least one C═C double bond that allows the olefins to undergo a polymerization reaction. The dynamic crosslinker has at least two polymerizable groups (e.g., a C═C double bond) that allow for the incorporation of the crosslinker into the polymer network during polymerization reaction. Because of the polymerizable groups contained in the dynamic crosslinker, the dynamic crosslinker can serve as another monomer during the polymerization, forming a copolymer or terpolymer with the olefin monomer or monomers. For instance, polymerization of an ethylene monomer using a diallyl disulfide as the crosslinker can generate an ethylene/diallyl disulfide copolymer; polymerization of ethylene monomer and vinyl acetate monomer using a diallyl disulfide as the crosslinker can generate an ethylene/vinyl acetate/diallyl disulfide terpolymer. The dynamic crosslinker also serve to link the polymer chains formed by the one or more monomers, forming an extensive crosslinking network.

The polymerization reaction can be carried out by various polymerization mechanisms known to one skilled in the art. For instance, free-radical polymerization is common polymerization mechanism and is suitable for the reaction herein. Free-radical polymerization is a type of chain-growth (chain-addition) polymerization that starts by initiating free radicals which add olefin or monomer units, thereby growing the polymer chain. Any type of initiation to generate free radicals (free radical initiation) can be suitable herein for the polymerization reactions. For instance, free radicals can be initiated by thermal initiation, radiation initiation (such as photo initiation), irradiation initiation (such as ionizing radiations, e.g., gamma and X-rays), or combinations thereof.

The reaction is typically carried out under a pressure above atmospheric pressure. For instance, the pressure for the polymerization and/or crosslinking reaction is at least 5 bar, and typically ranges from 5 bar to 5,000 bar, from 5 bar to 500 bar, from 5 bar to 200 bar, from 1000 bar to 5000 bar, from 1500 bar to 5000 bar, from 1000 bar to 3000 bar, from 1500 bar to 3000 bar, from 1000 bar to 2000 bar, or from 1000 bar to 3000 bar.

The reaction is typically carried out at an elevated temperature under a wide temperature range. The reaction temperature for the polymerization and/or crosslinking reaction is typically at least 30° C., and can range from 30° C. to 350° C., for instance, from 150° C. to 350° C., from 150° C. to 280° C., from 150° C. to 230° C., from 150° C. to 180° C., from 30° C. to 280° C., from 30°° C. to 230° C., from 30° C. to 180° C., or from 30° C. to 130° C. Suitable reaction temperatures should take into consideration the polymerization initiator used and the dynamic crosslinker used. For instance, suitable reaction temperatures should be at least higher than the decomposition temperature of the polymerization initiator. Suitable reaction temperatures should also be no higher than the dissociation temperature of the crosslinker so that the crosslinking bonds (i.e., the disulfide or polysulfide linkages) in the crosslinker do not dissociate during the reaction.

The reaction conditions may also involve the use of an inert gas (e.g., N₂ gas).

The reaction may be carried out in the presence or absence of a solvent. The solvent may be used to dissolve the monomer or dynamic crosslinker. Suitable solvents include, but are not limited to, deep eutectic solvents; eutectic mixtures; ionic liquids; dimethyl carbonate (green solvent); ethers such as petroleum ether, tetrahydrofuran, or 1,4-dioxane; hydrocarbon solvents such as cyclohexane, heptane, or toluene; esters such as ethyl acetate; ketones (such as acetone or butanone or clyclohexanone); chlorinated solvents, such as dichloromethane; alcohols such as methanol, ethanol, butan-2-ol, butan-1-ol, isopropanol, ethylene glycol, or glycerol; and combinations thereof. In some embodiments, the solvent is water, DMSO, dimethylformamide, butyrolactone, or 1,4-dioxane. In some embodiments, the solvent is an anhydrous liquid. In one embodiment, the solvent is dimethyl carbonate.

The polymerization and/or crosslinking reaction may be carried out in a batch process as a bulk reaction or in a continuous process as a continuous reaction, under the reaction temperature and pressure as discussed above.

To initiate the polymerization and/or crosslinking reaction, the amount of the polymerization initiator present in the polymerizable composition typically ranges from 1×10⁻⁷ wt % to 5.0 wt %, for instance, from 0.000001 wt % to 5 wt %, from 0.00001 wt % to 5 wt %, from 0.0001 wt % to 5 wt %, from 0.001 wt % to 5.0 wt %, from 0.05 wt % to 5.0 wt %, from 0.01 wt % to 5.0 wt %, from 0.05 wt % to 5.0 wt %, from 0.000001 wt % to 4 wt %, from 0.00001 wt % to 4 wt %, from 0.0001 wt % to 4 wt %, from 0.01 wt % to 4.0 wt %, from 0.05 wt % to 4.0 wt %, from 0.000001 wt % to 3 wt %, from 0.00001 wt % to 3 wt %, from 0.00001 wt % to 3 wt %, from 0.01 wt % to 3.0 wt %, from 0.05 wt % to 3.0 wt %, from 0.000001 wt % to 2 wt %, from 0.00001 wt % to 2 wt %, from 0.0001 wt % to 2 wt %, from 0.01 wt % to 2.0 wt %, from 0.05 wt % to 2.0 wt %, from 0.000001 wt % to 1 wt %, from 0.00001 wt % to 1 wt %, from 0.0001 wt % to 1 wt %, from 0.01 wt % to 1.0 wt %, from 0.05 wt % to 1.0 wt %, from 0.1 wt % to 1.0 wt %, or from 0.1 wt % to 0.5 wt %, relative to 100 wt % of the total amount of a polymerizable composition (comprising the ensemble of crosslinker molecules, olefins, and polymerization initiator).

Suitable olefins for the polymerization and/or crosslinking reaction are those described herein above. In some embodiments, the one or more olefins for the polymerization and/or crosslinking reaction comprise at least one member selected from the group consisting of ethylene, propylene, 1-butylene, 1-pentene, 1-hexene, 1-heptene, 1-octene, and vinyl acetate.

In one embodiment, the olefin for the polymerization and/or crosslinking reaction is ethylene. The ethylene polymer by polymerization may form high-density polyethylene (HDPE), linear low-density polyethylene (LLDPE), low-density polyethylene (LDPE), or medium-density polyethylene (MDPE).

The definition of olefin herein includes vinyl acetate. In one embodiment, ethylene and vinyl acetate are used as olefins for the polymerization and/or crosslinking reaction. The copolymer of ethylene and vinyl acetate by polymerization may form ethylene-vinyl acetate copolymer (EVA), also known as poly (ethylene-vinyl acetate) (PEVA), the type of which depends upon different vinyl acetate (VA) content: e.g., low-VA (approximately up to 4%) EVA, which has properties similar to a LDPE but has increased gloss, softness, and flexibility; medium-VA (approximately 4-30%) EVA, having properties of a thermoplastic elastomer material; and high-VA (greater than 33%) EVA, having properties similar to a rubber.

Suitable molecules for the ensemble of crosslinker molecules, for the polymerization and/or crosslinking reaction are those described herein above. In some embodiments, the ensemble of crosslinker molecules can comprises at least one member selected from the group consisting of diallyl disulfide, diallyl trisulfide, bis(2-methacryloyl)oxyethyl disulfide (DSDMA), ((((disulfanediylbis(4,1-phenylene))bis(azanediyl))bis(carbonyl))bis(azanediyl))bis(ethane-2,1-diyl)bis(2-methylacrylate) (4MUPD), diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, Disulfanediylbis(3,1-phenylene)diacrylate, disulfanediylbis(ethane-2,1-diyl)diacrylate, N,N′-(disulfanediylbis(2,1-phenylene))diacrylamide, N,N′-(disulfanediylbis(4,1-phenylene))diacrylamide, 4,13-dioxo-5,12-dioxa-8,9-dithia-3,14-diazahexadecane-1,16-diyl bis(2-methylacrylate) (ADSA), and N,N′-Bis(acryloyl)cystamine. In one embodiment, the crosslinker comprises diallyl disulfide.

The ensemble of crosslinker molecules may be present in the polymerizable composition at various amounts, for instance, in an amount ranging from 0.00001 wt % to 50 wt %, from 0.00001 wt % to 50 wt %, from 0.0001 wt % to 50 wt %, from 0.001 wt % to 50 wt %, from 0.05 wt % to 50 wt %, from 0.1 wt % to 50 wt %, from 0.5 wt % to 50 wt %, from 1 wt % to 50 wt %, from 5 wt % to 50 wt %, from 0.1 wt % to 40 wt %, from 0.5 wt % to 40 wt %, from 1 wt % to 40 wt %, from 5 wt % to 40 wt %, from 0.1 wt % to 30 wt %, from 0.5 wt % to 30 wt %, from 0.1 wt % to 20 wt %, from 0.5 wt % to 20 wt %, from 1 wt % to 20 wt %, from 5 wt % to 20 wt %, from 0.1 wt % to 10 wt %, from 0.5 wt % to 10 wt %, from 1 wt % to 10 wt %, or from 5 wt % to 10 wt %, relative to 100 wt % of the total amount of the polymerizable composition (comprising the ensemble, olefins, and polymerization initiator). In terms of mol %, the ensemble of crosslinker molecules may be present in the polymerizable composition in an amount of at least 0.00001 mol %, at least 0.0001 mol %, at least 0.001 mol %, at least 0.05 mol %, at least 0.1 mol %, at least 0.5 mol %, at least 1 mol %, at least 2 mol %, at least 3 mol %, at least 4 mol %, at least 5 mol %, or in a range of from 0.01 mol % to 35 mol % (e.g., from 0.05 mol % to 35 mol %, from 0.1 mol % to 35 mol %, from 0.5 mol % to 35 mol %, from 1 mol % to 35 mol %, from 5 mol % to 35 mol %, from 1 mol % to 30 mol %, from 5 mol % to 30 mol %, from 1 mol % to 25 mol %, from 5 mol % to 25 mol %, from 1 mol % to 20 mol %, from 5 mol % to 20 mol %, from 1 mol % to 15 mol %, from 5 mol % to 15 mol %, from 1 mol % to 10 mol %, or from 5 mol % to 10 mol %), relative to 100 mol % of the total amount of the polymerizable composition (comprising the ensemble, olefins, and polymerization initiator).

An embodiment of this invention also relates to a polymer formed from the methods disclosed above. A further embodiment of this invention relates to an article formed from the polymer. Suitable articles include, but are not limited to, a wire or cable, a foam, an injection-molded article, a profile-extrusion article, a compression molded article, a film or sheet, an adhesive, a pipe, a compound composition, and a fiber. The above disclosure and embodiments relating to the processes of preparing the polymer, including the olefins, the ensemble of crosslinker molecules, the polymerization initiator, and the reaction conditions, all represent corresponding embodiments for the polymer formed from the methods and articles formed from the polymer.

### EXAMPLES

Ethylene, N,N′-Bis(acryloyl)cystamine (BAC, 95%, Achmem), tert-amylperoxypivalate, n-heptane (99%, Sigma Aldrich), vinyl acetate (99%, Sigma Aldrich) were used as received. BiTEMPS methacrylate (biTEMPS-S2 or biTEMPS-S+ was synthesized as described from procedures reported in literature. See Tapas Debsharma et al., “BiTEMPS methacrylate dynamic covalent cross-linker providing rapid reprocessability and extrudability of covalent adaptable networks: high-yield synthesis with strong selectivity for disulfide linkages,” Polym. Chem., 15 (2024) pp. 2167-2176, herein incorporated by reference in its entirety.

### Example 1

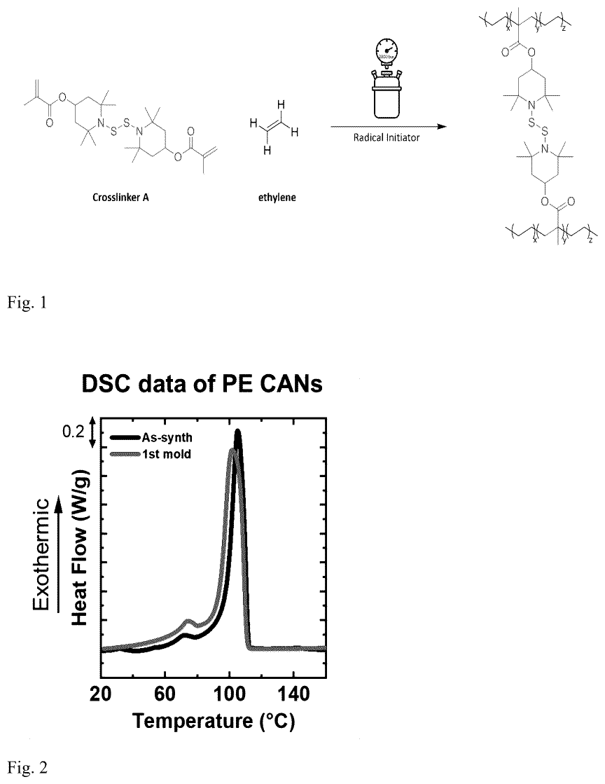

Polymers were prepared using a high-pressure autoclave through free radical polymerization. FIG. 1 provides an example of this reaction. To produce polymer samples A1-A5, various loadings of comonomer A (biTEMPS-S2, ≥95% disulfide linkages) or comonomer B (biTEMPS-S+, <90% disulfide linkages) were loaded in the high-pressure autoclave. The reactor was pre-heated and pre-pressurized with ethylene. To initiate polymerization, a mixture of radical initiator and n-heptane were introduced into the reactor and pressure increased to 2000 bar. After the initiator solution was injected, the temperature was held constant for 5 minutes. The polymers collected produced polymer samples A1-A5 and B1 as seen in Table 1.

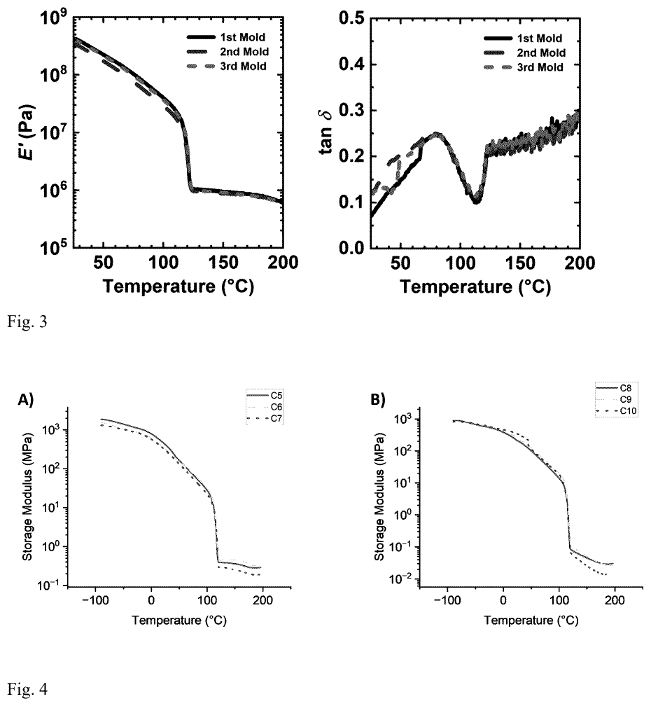

Polymer sample A2, a polyethylene/biTEMPS-S2 co-polymer, was characterized via solid state NMR, DMA, DSC, and swelling studies. Solid state NMR was used to determine the incorporation of biTEMPS-S2 into the PE network for each of the samples, as seen in Table 1. DSC shown in FIG. 2 shows that the crystallization temperature (T_{c}) does not change after a remolding step. The DSC data for the polymer A2 sample run in FIG. 2 is shown in Table 2.1. Additional DSC data, including data for another polymer A2 sample, is shown in Table 2.2. Polymer A2 was molded for DMA by pressing the polymer at 180° C. for 30 minutes with 8-10 tons of pressure. The material was cut up and reprocessed with the same processing conditions to obtain the 2nd and 3rd mold samples. The DMA shown in FIG. 3 exhibits a rubbery plateau above 120° C. indicating a crosslinked polymer network and the storage modulus is maintained through 3 reprocessing steps, indicating a recyclable polymer network.

Comonomer A (biTEMP-S2) co-polymerizations were successful in producing co-polymer with ethylene that exhibited crosslinked behavior and was re-processable; Table 1, samples A1-A5. When comonomer B (biTEMPS-S+) was used, polymerizations were unsuccessful and negligible polymer was obtained; Table 1 sample B1. This is attributed to the additional sulfur atoms (n>2) present in comonomer B (biTEMPS-S+).

TABLE 1
Example 1 polymerizations.

| | | Amount of | | | | Polymer | | Comonomer |
|---|---|---|---|---|---|---|---|---|
| Polymer | | comonomer | | Xᵢₙᵢₐₜₒᵣ | T | yield | Conversion | incorporation |
| Sample | comonomer | (mol %) | initiator | (molppm) | (° C.) | (g) | (wt %) | (wt %) |
| A1 | BiTEMPS- | 0.1 | EHPC | 150 | 70 | 0.29 | 1.70 | — |
| | S2 | | | | | | | |
| A2 | BiTEMPS- | 0.03 | EHPC | 150 | 70 | 4.36 | 25.70 | 2.27 |
| | S2 | | | | | | | |
| A3 | BiTEMPS- | 0.03 | EHPC | 75 | 90 | 2.01 | 12.10 | 1.90 |
| | S2 | | | | | | | |
| A4 | BiTEMPS- | 0.03 | TAPPI | 30 | 130 | 0.09 | 0.56 | — |
| | S2 | | | | | | | |
| AS | BiTEMPS- | 0.05 | TAPPI | 75 | 160 | 0.26 | 1.70 | 0.68 |
| | S2 | | | | | | | |
| B1 | BiTEMPS- | 0.1 | TAPPI | 4 | 155 | 0 | 0 | — |
| | S+ | | | | | | | |

TABLE 2.1
DSC data for polymer sample in FIG. 2.

| | T_{c, peak 1} | T_{c, peak 2} | Crystallinity |
|---|---|---|---|
| Mold | (° C.) | (° C.) | (%) |
| As-synthesized | 72 | 105 | 36 |
| 1^{st} Mold | 74 | 102 | 36 |

TABLE 2.2
DSC data including Tₘ (second heating cycle), T_{c},
and ΔH (second heating cycle) of select polymer samples.

| | | Amount of | T_{c} | Tₘ | |
|---|---|---|---|---|---|
| Polymer | | comonomer | peak | peak | Endothermic |
| Sample | comonomer | (mol %) | (° C.) | (° C.) | ΔH (J/g) |
| A2 | biTEMPS | 0.03 | 108.18 | 119.34 | 135.46 |
| A3 | biTEMPS | 0.03 | 109.29 | 119.78 | 144.31 |
| A5 | biTEMPS | 0.05 | 103.70 | 113.54 | 133.26 |
| C2 | BAC | 0.072 | 98.51 | 111.90 | 121.89 |
| C3 | BAC | 0.036 | 98.34 | 111.72 | 92.773 |
| C4 | BAC | 0 | 107.31 | 119.52 | 140.53 |
| C5 | BAC | 0.01 | 108.68 | 118.31 | 131.72 |
| C6 | BAC | 0.01 | 107.38 | 117.70 | 140.08 |
| C7 | BAC | 0.01 | 106.80 | 117.27 | 149.20 |
| C8 | BAC | 0.02 | 106.39 | 120.37 | 129.61 |
| C9 | BAC | 0.02 | 106.23 | 118.61 | 131.02 |
| C10 | BAC | 0.03 | 107.27 | 117.89 | 131.47 |
| C11 | BAC | 0.005 | 69.40 | 82.70 | 51.786 |
| C12 | BAC | 0.005 | 59.74 | 74.54 | 49.918 |
| C13 | BAC | 0.01 | 60.94 | 75.75 | 43.955 |

### Example 2

Polymers were prepared using a high-pressure autoclave through free radical polymerization, as seen in FIG. 1. To produce polymer samples C1-C3, various loadings of comonomer C (BAC) were loaded in the high-pressure autoclave. The reactor was pre-heated and pre-pressurized with ethylene. To initiate polymerization, a mixture of radical initiator and n-heptane were introduced into the reactor and pressure increased to 2000 bar. After the initiator solution was injected, the temperature was held constant for 5 minutes. The polymers collected produced polymer samples C1-C3, Table 3.

Polymer samples C2 and C3, polyethylene/BAC co-polymers, were characterized via DSC, DMA. Table 2.2 shows the Tm, Tc, and ΔH.

TABLE 3
Example 2 polymerizations.

| | | Amount of | | | | Polymer | |
|---|---|---|---|---|---|---|---|
| Polymer | | comonomer | | Xᵢₙᵢₐₜₒᵣ | T | yield | Conversion |
| Sample | comonomer | (mol %) | initiator | (molppm) | (° C.) | (g) | (wt %) |
| C1 | BAC | 0.072 | TAPPI | 1 | 160 | 0.25 | 1.66 |
| C2 | BAC | 0.072 | TAPPI | 10 | 165 | 0.65 | 4.30 |
| C3 | BAC | 0.036 | TAPPI | 10 | 165 | 0.88 | 5.60 |

### Example 3

A series of polymers were prepared using a continuous free radical polymerization with comonomer mixtures by combining flows of ethylene, vinyl acetate, and comonomer C (BAC) into a high-pressure reactor. Each polymerization started with heating the reactor to 165° C. and feeding ethylene to a pressure of 1900-2000 bar. A continuous flow of ethylene with a rate of 300 g/hr was fed into the reactor. Once the targeted pressure and stable ethylene flow was achieved, the comonomers were added to the reactor. Comonomer C was dissolved in DMSO and fed as a solution into the reactor. A mixture of radical initiator and heptane was introduced to the system with a flow rate of 2-6 ml/hr. The polymerization samples were collected and reported in Table 4.

TABLE 4
Example 3 polymerizations

| | ethylene | isobutane | vinyl | | comonomer | Initiator | sample | |
|---|---|---|---|---|---|---|---|---|
| Polymer | feed | feed | acetate feed | | feed | feed | amount | % |
| Sample | (g/hr) | (g/hr) | (wt %) | Comonomer | (mol %) | (ml/hr) | (g) | conversion |
| C4 | 300 | 15 | 0 | BAC | 0 | 2 | 6.34 | 4.2 |
| C5 | 300 | 15 | 0 | BAC | 0.01 | 3 | 5.44 | 3.6 |
| C6 | 300 | 15 | 0 | BAC | 0.01 | 4 | 4.05 | 5.3 |
| C7 | 300 | 15 | 0 | BAC | 0.01 | 4 | 3.87 | 5.1 |
| C8 | 300 | 15 | 0 | BAC | 0.02 | 4.5 | 7.70 | 5.1 |
| C9 | 300 | 15 | 0 | BAC | 0.02 | 4.5 | 4.76 | 6.3 |
| C10 | 300 | 15 | 0 | BAC | 0.03 | 5.5 | 4.91 | 6.5 |
| C11 | 300 | 15 | 26 | BAC | 0.005 | 3 | 0.72 | 1.1 |
| C12 | 300 | 15 | 28 | BAC | 0.005 | 4 | 16.92 | 6.1 |
| C13 | 300 | 15 | 24 | BAC | 0.01 | 5 | 6.71 | 6.6 |

Polymer samples C4-C10, polyethylene/BAC co-polymers, and C11-C13, polyethylene vinyl acetate/BAC ter-polymers were characterized via DSC. FIG. 4 depicts the DSC characterization of polymer samples C5-C10. Table 2.2 shows the Tm, Tc, and ΔH obtained from DSC. These samples contain comonomer C and exhibited the expected rubbery plateau, indicating the polymer samples are crosslinked.

What is claimed is:

1. A method of making a polymer, comprising:
reacting an olefin in the presence of an ensemble of crosslinker molecules, each molecule of the ensemble comprising a —Sₙ— moiety and having at least two polymerizable groups, wherein n is an integer of from 1 to 8, in the presence of a polymerization initiator, to produce a reversibly-crosslinked polymer that comprises crosslinking bonds, said crosslinking bonds being bonds that dissociate when the reversibly-crosslinked polymer is reprocessed at temperatures 50° C. or greater,
wherein, for at least 90% of the crosslinkers molecules in the ensemble, n is equal to 2.

2. The method according to claim 1, wherein the ensemble of crosslinker molecules comprises molecules represented by Formula (I), (II), (III), (IV), (V), or (VI): 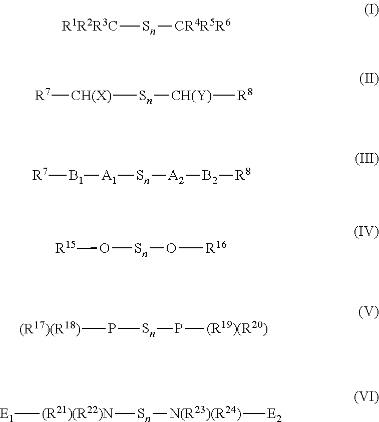
wherein:
n is an integer of from 2 to 8;
X represents CHR⁹R¹⁰, OH, SH, or NHR¹¹;
Y represents CHR¹²R¹³, OH, SH, or NHR¹⁴;
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silcone having from 1 to 20 carbon atoms; each optionally substituted by one or more alkyl, alkenyl, hydroxyl, or halogen atoms, wherein adjacent R groups can together form a saturated or unsaturated hydrocarbon ring;
each of A₁ and A₂ is independently absent, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, amide, ether, or ester, or combinations thereof; and
each of E₁ and E₂ is independently a (meth)acrylate, (meth)acrylamide, a C₁-C₂₀ alkylene, a C₃-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
provided the following:
in Formula (I), at least one of R¹, R², and R³ comprises a C═C double bond and at least one of R⁴, R⁵, and R⁶ comprises a C═C double bond,
in Formula (II) and (III), each of R⁷ and R⁸ comprises a C═C double bond,
in Formula (IV), each of R¹⁵ and R¹⁶ comprises a C═C double bond,
in Formula (V), each of R¹⁷, R¹⁸, R¹⁹, and R²⁰, comprises a C═C double bond, and
in Formula (VI), each of E₁ and E₂ comprises a C═C double bond,
wherein, for at least 90% of the crosslinkers molecules in the ensemble, n is equal to 2.

3. The method according to claim 1 or 2, wherein, for at least 91% of the crosslinkers molecules in the ensemble, n is equal to 2.

4. The method according to claim 1 or 2, wherein, for at least 92% of the crosslinkers molecules in the ensemble, n is equal to 2.

5. The method according to claim 1 or 2, wherein, for at least 93% of the crosslinkers molecules in the ensemble, n is equal to 2.

6. The method according to claim 1 or 2, wherein, for at least 94% of the crosslinkers molecules in the ensemble, n is equal to 2.

7. The method according to claim 1 or 2, wherein, for at least 95% of the crosslinkers molecules in the ensemble, n is equal to 2.

8. The method according to claim 1 or 2, wherein, for at least 96% of the crosslinkers molecules in the ensemble, n is equal to 2.

9. The method according to claim 1 or 2, wherein, for at least 97% of the crosslinkers molecules in the ensemble, n is equal to 2.

10. The method according to claim 1 or 2, wherein, for at least 98% of the crosslinkers molecules in the ensemble, n is equal to 2.

11. The method according to claim 1 or 2, wherein, for at least 99% of the crosslinkers molecules in the ensemble, n is equal to 2.

12. The method according to claim 1, wherein said reacting is carried out under a pressure of at least 20 bar.

13. The method according to claim 1, wherein said reacting is carried out under a pressure of from 20 bar to 5,000 bar.

14. The method according to claim 1, wherein said reacting is carried out under a pressure of from 1500 bar to 2000 bar.

15. The method according to claim 1, wherein the polymerization initiator is a free-radical initiator, a thermal initiator, radiation or irradiation, or any combination thereof.

16. The method according to claim 1, wherein the polymerization initiator is present in an amount of from 1×10⁻⁷ to 5 wt %, relative to 100 wt % of the total amount of the ensemble of crosslinker molecules, olefin, and the polymerization initiator.

17. The method according to claim 1, wherein the polymerization initiator comprises at least one member selected from the group consisting of a peroxide, an azo compound, a peracetate compound, and a nitroxide.

18. The method according to claim 17, wherein the polymerization initiator comprises at least one peroxide selected from the group consisting of benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di (tert-butylperoxide) hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide) valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentano1; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy)hexane; 2,5-dimethyl-2,5-di(t-amylperoxy)hexane; 2,5-dimethyl-2,5-di(t-butylperoxy)hexyne-3,2,5-dimethyl-2,5-di(t-amylperoxy)hexyne-3, 2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyljbenzene; 1,3-dimethyl-3-(t-butylperoxy)butanol; 1,3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobomyl)peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl) 1-methylethyl]carbamate; 1,3-dimethyl-3-(t-amylperoxy)butyl N-[1-{3 (1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1, 4, 7-triperoxynonane (or methyl ethyl ketone peroxide cyclic trimer); methyl ethyl ketone peroxide cyclic dimer: 3,3,6,6,9,9-hexamethyl-1,2,4,5-tetraoxacyclononane; 2,5-dimethyl-2,5-di(benzoylperoxy)hexane; t-butyl perbenzoate, t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy) propionate; allyl 3-methyl-3-t-butylperoxy butyrate: OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,-tris[2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide, succinic acid peroxide, dibenzoyl peroxide; di(2,4-dichloro-benzoyl) peroxide; and combinations thereof.

19. The method according to claim 1, wherein the polymerization initiator comprises at least one member selected from the group consisting of
di (2-ethylhexyl) peroxydicarbonate (EHPC), tert-amyl peroxypivalate (TAPPI);
tert-butylperoxy-2-ethylhexanoate (TBPEH);
tert-butylperoxyacetate (TBPA);
azobisisobutyronitrile (AIBN);
2,2′-azobis (amidinopropyl) dihydrochloride;
2,3-dimethyl-2,3-diphenylbutane;
3,4-dimethyl-3,4-diphenylhexane;
3,4-diethyl-3,4-diphenylhexane;
3,4-dibenzyl-3,4-ditolylhexane;
2,7-dimethyl-4,5-diethyl-4,5-diphenyloctane;
3,4-dibenzyl-3,4-diphenylhexane; and
an azo-peroxide initiator that comprises a peroxide and at least one azodinitrile compound selected from the group consisting of 2,2′-azobis (2-methyl-pentanenitrile); 2,2′-azobis (2-methyl-butanenitrile); 2,2′-azobis (2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile.

20. The method according to claim 1, wherein said reacting is carried out as a batch reaction or a continuous reaction, under a pressure of at least 20 bar.

21. The method according to claim 1, wherein said reacting is carried out at a temperature of at least 70° C.

22. The method according to claim 1, wherein said reacting is carried out at a temperature of from 70° C. to 350° C.

23. The method according to claim 1, wherein said reacting is carried out at a temperature of from 150° C. to 350° C.

24. The method according to claim 1, wherein the ensemble of crosslinker molecules comprises at least one member selected from the group consisting of
bis(2-methacryloyl)oxyethyl disulfide,
disulfanediylbis(3,1-phenylene)diacrylate,
disulfanediylbis(ethane-2,1-diyl)diacrylate,
N,N′-(disulfanediylbis(2,1-phenylene))diacrylamide,
N,N′-(disulfanediylbis(4,1-phenylene))diacrylamide,
N,N′-bis(acryloyl)cystamine,
4,13-dioxo-5,12-dioxa-8,9-dithia-3,14-diazahexadecane-1,16-diyl bis(2-methylacrylate), and
bis (2,2,6,6-tetramethyl-4-piperidyl)disulfide.

25. The method according to claim 1, wherein the ensemble of crosslinker molecules comprises bis(2,2,6,6-tetramethyl-4-piperidyl)disulfide.

26. The method according to claim 1, wherein the crosslinking bonds are sulfur-sulfur bonds that dissociate at temperatures 50° C. or greater.

27. The method according to claim 1, wherein the olefin comprises at least one member selected from the group consisting of ethylene, propylene, 1-butylene, 1-pentene, 1-hexene, 1-heptene, 1-octene, and vinyl acetate.

28. The method according to claim 1, wherein the olefin comprises ethylene, propylene, a combination of ethylene and vinyl acetate, or a combination thereof.

29. The method according to claim 1, which is carried out in a gas-phase reactor.

30. A polymer formed from the method of claim 1.

31. An article formed from the polymer of claim 30, wherein the article is selected from the group consisting of a wire or cable, a foam, an injection-molded article, a profile-extrusion article, a compression molded article, a film or sheet, an adhesive, a pipe, a compound composition, and a fiber.
